(19) United States
(12) Patent Application Publication
(10) Pub. No.: US 2026/0034805 A1
(43) Pub. Date: Feb. 5, 2026

(54) PRINTER DEVICE

(71) Applicant: TOSHIBA TEC KABUSHIKI KAISHA, Tokyo (JP)

(72) Inventor: Akira Suzuki, Mishima Shizuoka (JP)

(21) Appl. No.: 19/172,695

(22) Filed: Apr. 8, 2025

(30) Foreign Application Priority Data
Aug. 1, 2024 (JP) 2024-125613

(51) Int. Cl. B41J 11/00; B41J 2/32; B41J 11/04; B41J 11/70; B41J 15/04; B41J 15/16

(52) U.S. Cl. CPC B41J 11/0005; B41J 2/32; B41J 11/0095; B41J 11/04; B41J 11/70; B41J 15/046; B41J 15/165

(57) ABSTRACT

According to one embodiment, a printer device according to an embodiment includes: an accommodation portion configured to accommodate paper wound in a roll shape; a conveyance unit configured to pull out the paper from the accommodation portion and convey the paper; a printing unit configured to print on the paper conveyed by the conveyance unit; a damper unit provided between the accommodation portion and the printing unit and configured to abut against the paper from a winding outer surface side of the paper to apply an elastic force to the paper; and a guide unit facing the damper unit and configured to form, between the guide unit and the damper unit, a conveyance path of the paper having a curved surface opposite to the curling tendency of the paper.

### CROSS-REFERENCE TO RELATED APPLICATION

This application is based upon and claims the benefit of priority from Japanese Patent Application No. 2024-125613, filed on Aug. 1, 2024, the entire contents of which are incorporated herein by reference.

### FIELD

Embodiments described herein relate generally to a printer device, a thermal printer, and methods related thereto.

### BACKGROUND

In the related art, there is a printer device that pulls out paper from rolled paper wound in a roll shape and prints on the pulled-out paper. For example, in a thermal printer which is an example of a printer device, paper is pulled out from rolled paper by a conveyance roller such as a platen roller, and printing is performed by a thermal head that faces the platen roller. There is also a printer device including a cutter mechanism that cuts a paper portion on which printing is performed.

Meanwhile, the paper pulled out from the rolled paper is curled due to curling tendency, and curvature thereof increases as a diameter (winding diameter) of the rolled paper decreases. In the above-described printer device, when curled paper is conveyed, a leading end portion of the paper may be caught in unevenness, a gap, or the like on a conveyance path, and a jam may occur.

However, in the printer device in the related art, a mechanism for removing the curl of the rolled paper (curl removing mechanism) is not provided in many cases. In addition, in the related art, a printer device is proposed that can switch between a correctable position and a retreat position by controlling an arrangement position of a conveyance roller that corrects curling tendency of rolled paper depending on a winding diameter (number of turns) of the rolled paper, but the configuration is complicated, and there is room for further improvement.

### DESCRIPTION OF THE DRAWINGS

FIG. 1 is a perspective view illustrating an example of an appearance of a printer device according to an embodiment;

FIG. 2 is a diagram illustrating an example of an internal configuration of the printer device;

FIG. 3 is a partially enlarged view of a platen roller and a first guide unit illustrated in FIG. 2;

FIG. 4 is a diagram illustrating an example of a hardware configuration of the printer device; and

FIG. 5 is a flowchart illustrating an example of printing performed by the printer device.

### DETAILED DESCRIPTION

A printer device capable of printing while reducing curling tendency that occurs in rolled paper is provided.

In general, according to one embodiment, a printer device includes an accommodation portion, a conveyance unit, a printing unit, a damper unit, and a guide unit. The accommodation portion accommodates paper wound in a roll shape. The conveyance unit pulls out the paper from the accommodation portion and conveys the paper. The printing unit prints on the paper conveyed by the conveyance unit. The damper unit is provided between the accommodation portion and the printing unit, and abuts against the paper from a winding outer surface side of the paper to apply an elastic force to the paper. The guide unit faces the damper unit, and forms, between the guide unit and the damper unit, a conveyance path of the paper having a curved surface opposite to curling tendency of the paper. According to another embodiment, a method of mitigating paper curling involves accommodating paper wound in a roll shape an accommodation portion of a printer; pulling out the paper from the accommodation portion and conveying the paper using a conveyance component; printing on the paper conveyed; abutting a damper component against the paper from a winding outer surface side of the paper so as to apply an elastic force to the paper using a damper component between the accommodation portion and the printer; and forming, between the guide component and the damper component, a conveyance path of the paper having a curved surface opposite to a curling tendency of the paper using a guide component facing the damper component.

Hereinafter, the embodiment will be described in detail with reference to the drawings. The disclosure is not limited to the embodiment to be described later.

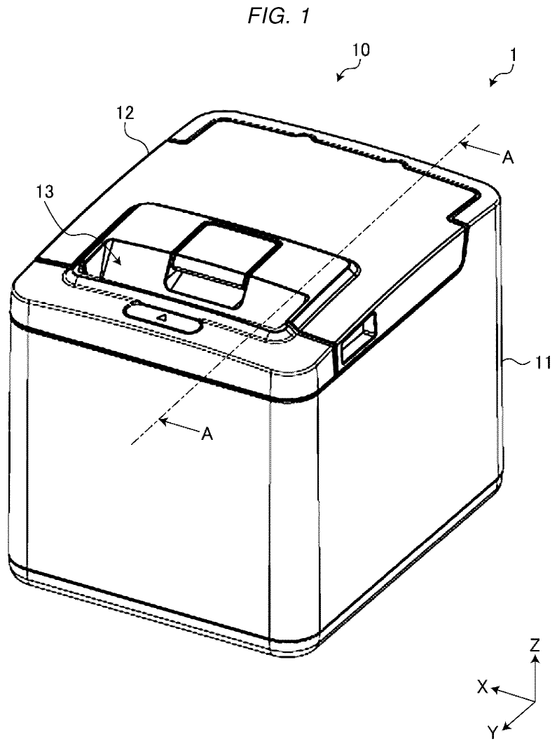

FIG. 1 is a perspective view illustrating an example of an appearance of a printer device 1 according to the embodiment. In the present embodiment, the printer device 1 is a thermal printer and is an example of a printer device.

In the drawings described below, a left-right direction (X direction), a front-rear direction (Y direction), and an upper-lower direction (Z direction) in the printer device 1 are described using an X axis, a Y axis, and a Z axis orthogonal to each other. In the following description, when simply described as the X direction, the Y direction, or the Z direction, these are axial directions and include two opposite directions. In addition, when a positive direction of the X axis is specified, the positive direction of the X axis is a direction from a right side to a left side, when a positive direction of the Y axis is specified, the positive direction of the Y axis is a direction from a rear side to a front side, and when a positive direction of the Z axis is specified, the positive direction of the Z axis is a direction from a lower side to an upper side.

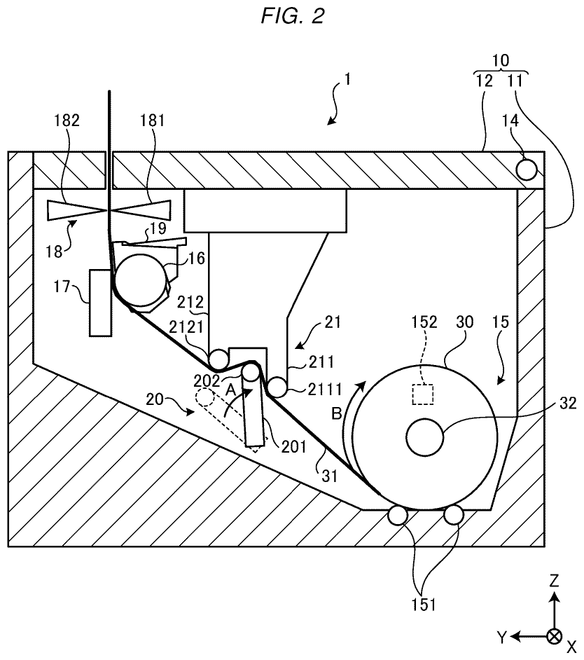

The printer device 1 includes a lower housing 11, an upper cover 12, and a discharge port 13. The lower housing 11 is a box-shaped container having an opening on one surface. The lower housing 11 is provided with a connection terminal (not illustrated) used for connection to an external device such as a host computer that manages the printer device 1, a power supply terminal (not illustrated) that supplies power to a printer body, and the like. The upper cover 12 opens and closes the accommodation portion 15. The upper cover 12 is an example of a lid. The upper cover 12 has one end pivotably supported on the lower housing 11 by an upper cover pivot shaft 14 (see FIG. 2), and opens and closes the opening of the lower housing 11 as the upper cover 12 pivots. The lower housing 11 and the upper cover 12 constitute a housing 10.

The discharge port 13 is a gap-shaped opening through which paper is discharged. FIG. 1 illustrates an example in which the discharge port 13 is provided on an upper surface of the printer device 1.

Next, an internal configuration of the printer device 1 will be described with reference to FIG. 2. FIG. 2 is a diagram illustrating an example of the internal configuration of the printer device 1 according to the embodiment. FIG. 2 schematically illustrates a cross section of the printer device 1 illustrated in FIG. 1 in the YZ direction taken along line A-A.

As illustrated in FIG. 2, the printer device 1 accommodates, in the housing 10, a rolled paper 30 obtained by winding a long paper 31 around a roll core 32. The printer device 1 prints while pulling out the paper 31 from the accommodated rolled paper 30.

The paper 31 is, for example, thermal paper. The paper 31 may be a thermal label paper. The thermal label paper may be a label in which labels having a predetermined size are attached side by side on a strip-shaped mount, or may be a strip-shaped label without a mount. Hereinafter, among surfaces of the paper 31 pulled out from the rolled paper 30, one surface located on an outer side (outer peripheral side) of the rolled paper 30 is also referred to as a “winding outer surface side”, and the other surface located on an inner side (inner peripheral side) of the rolled paper 30 is also referred to as a “winding inner surface side”.

The printer device 1 includes, inside the housing 10, an accommodation portion 15, a platen roller 16, a thermal head 17, a cutter mechanism 18, and a first guide unit 19.

The accommodation portion 15 is an example of an accommodation portion. The accommodation portion 15 is a space for accommodating the rolled paper 30 provided inside the housing 10. The accommodation portion 15 accommodates the rolled paper 30 inserted into the housing 10.

The accommodation portion 15 includes a rolled paper rotation unit 151 for rotating the rolled paper 30 on a bottom surface portion that comes into contact with the accommodated rolled paper 30. The rolled paper rotation unit 151 is an example of a rotation unit.

The rolled paper rotation unit 151 is formed of a roller, a belt, or the like capable of rotating the rolled paper 30 in a conveyance direction (a feed direction and a back-feed direction described later). The rolled paper rotation unit 151 is driven by a drive source (not illustrated) such as a stepping motor. The accommodation portion 15 may not include the rolled paper rotation unit 151.

The accommodation portion 15 is provided with a sensor unit 152 for detecting a winding diameter, a remaining amount, and a near-end approaching an end of the rolled paper 30. The sensor unit 152 is an example of a sensor unit. A form of the sensor unit 152 is not particularly limited, and may be implemented by, for example, a reflective photosensor.

In the present embodiment, an example is illustrated in which a so-called throw-in method is adopted in which the roll core 32 of the rolled paper 30 is not pivotably supported in the accommodation portion 15, but the disclosure is not limited to this configuration. For example, a configuration may be adopted in which the roll core 32 of the rolled paper 30 is rotatably pivoted by providing a bearing or the like in the accommodation portion 15.

If the throw-in method is adopted, the printer device 1 may include a member (hereinafter, also referred to as a flapper) for pressing the rolled paper 30 accommodated in the accommodation portion 15 from above and pressing the rolled paper 30 against an inner wall of the accommodation portion 15. In this case, one end side of the flapper is pivotably attached to, for example, a back side of the upper cover 12, and the other end side is biased in a bottom surface direction of the accommodation portion 15 by a biasing member such as a torsion spring.

The platen roller 16 is an example of a conveyance unit. The platen roller 16 is provided, for example, on a back surface side of the upper cover 12. The platen roller 16 is rotated by a driving force transmitted from a drive source such as a stepping motor (not illustrated). The platen roller 16 pulls out the paper 31 from n the rolled paper 30 accommodated in the accommodation portion 15 and conveys the paper 31 toward the discharge port 13.

The thermal head 17 is an example of a printing unit. The thermal head 17 is installed, for example, on an inner surface of the lower housing 11. The thermal head 17 abuts against the platen roller 16 when the upper cover 12 is closed.

The thermal head 17 has a structure in which a plurality of heating elements are aligned. The paper 31 is conveyed toward the discharge port 13 while being sandwiched between the thermal head 17 and the platen roller 16. The thermal head 17 prints on the paper 31 sandwiched between the thermal head 17 and the platen roller 16 by causing a heating element corresponding to a printing pattern to generate heat.

Hereinafter, a sandwiching position between the thermal head 17 and the platen roller 16 is also referred to as a printing position. The conveyance direction of the paper 31 conveyed from the rolled paper 30 toward the discharge port 13 is also referred to as a “feed direction”. Conveying in a direction opposite to the feed direction is also referred to as “back-feed”, and a conveyance direction during back-feeding is also referred to as a back-feed direction. The terms “upstream” and “downstream” in the conveyance direction mean “upstream” and “downstream” when conveying in the feed direction.

The cutter mechanism 18 is an example of a cutting unit. The cutter mechanism 18 is installed, for example, on the back surface side of the upper cover 12. The cutter mechanism 18 is located between the thermal head 17 (and the platen roller 16) and the discharge port 13 when the upper cover 12 is closed.

The cutter mechanism 18 includes a first blade 181 and a second blade 182. One of the first blade 181 and the second blade 182 is a fixed blade, and the other is a movable blade. The first blade 181 and the second blade 182 face each other across the conveyance path of the paper 31. The cutter mechanism 18 has a drive source for driving the movable blade. The cutter mechanism 18 cuts the paper 31 placed between the fixed blade and the movable blade by moving the movable blade toward the fixed blade.

In the present embodiment, the cutter mechanism 18 is provided integrally with the printer device 1, but the disclosure is not limited thereto, and the cutter mechanism 18 may be detachable from the printer device 1.

The first guide unit 19 is provided, for example, on the back surface side of the upper cover 12 and around the platen roller 16. Specifically, the first guide unit 19 is provided between the platen roller 16 and the cutter mechanism 18, and functions as a guide member for smoothly moving the paper 31 conveyed between the platen roller 16 and the cutter mechanism 18. The first guide unit 19 may rotatably hold the platen roller 16.

The printer device 1 rotates the platen roller 16 in the feed direction to pull out the paper 31 from the rolled paper 30 and prints by the thermal head 17. The printer device 1 outputs a printed result by discharging a printed portion of the rolled paper 30 from the discharge port 13 and cutting the portion with the cutter mechanism 18. Then, the printer device 1 conveys the paper 31 in the back-feed direction to return a leading end portion of the paper 31 to the printing position of the thermal head 17, and prepares for next printing.

The printer device 1 further includes a damper unit 20. The damper unit 20 is an example of a damper unit. The damper unit 20 is provided between the accommodation portion 15 and the platen roller 16 inside the lower housing 11. The damper unit 20 abuts against the paper 31 from one surface side (winding outer surface side) of the paper 31 and applies an elastic force to the paper 31, thereby reducing tension applied to the paper 31 by being pulled out by the platen roller 16.

Specifically, the damper unit 20 includes a frame portion 201 and a rotation roller 202. The frame portion 201 is, for example, a plate-shaped member provided over a width direction (X direction) of the printer device 1. The rotation roller 202 is provided on an upper end side (one end side) of the frame portion 201 and is rotatable in the conveyance direction of the paper 31.

A lower end side (the other end side) of the frame portion 201 is pivotably fixed to a pivot shaft (hereinafter, also referred to as a frame pivot shaft) provided over the width direction (X direction) of the printer device 1. The frame portion 201 is biased in a clockwise direction indicated by an arrow A in the drawing by a biasing member such as a torsion spring.

Accordingly, the rotation roller 202 abuts against and presses the paper 31 conveyed by the platen roller 16 from the one surface side (winding outer surface side) of the paper 31, thereby forming a projected region (hereinafter, also referred to as a buffer region) on the paper 31.

When the tension is applied to the paper 31 by the platen roller 16 conveying the paper 31 in the feed direction, the rotation roller 202 is pressed by the tension generated in the paper 31, causing the frame portion 201 to rotate counterclockwise. At this time, since the tension generated in the paper 31 is buffered by the buffer region, the tension exerted on the rolled paper 30 is reduced.

In this way, the damper unit 20 reduces the tension applied to the paper 31 by forming the buffer region between the platen roller 16 and the rolled paper 30. Accordingly, the paper 31 can be stably conveyed, so that printing quality can be improved.

It is assumed that a pivot area of the frame portion 201 is limited between a pivot position in a biased state indicated by the solid line in FIG. 2 and a pivot position indicated by a broken line in FIG. 2. Hereinafter, the pivot position in the biased state is also referred to as a “biasing position”.

The paper 31 pulled out from the rolled paper 30 is curled in accordance with the curling tendency. For example, in the configuration in FIG. 2, as indicated by an arrow B, a curl curved toward the winding inner surface side occurs on the paper 31. The smaller the diameter (winding diameter) of the rolled paper 30, the greater curvature of the curl.

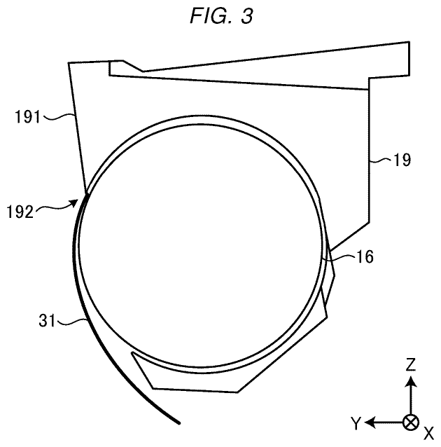

When the curled paper 31 is conveyed, the leading end portion of the paper 31 may be caught in unevenness, a gap, or the like on the conveyance path, and a jam may occur. For example, in the configuration in FIG. 2, as illustrated in FIG. 3, a leading end of the paper 31 may enter a gap portion between the platen roller 16 and the first guide unit 19.

FIG. 3 is a partially enlarged view of the platen roller 16 and the first guide unit 19 illustrated in FIG. 2. As illustrated in FIG. 3, the first guide unit 19 includes a wall surface 191 for guiding the paper 31 in a tangential direction of the platen roller 16 with which the paper 31 comes into contact. A gap 192 is provided between the platen roller 16 and the wall surface 191 to allow the platen roller 16 to rotate smoothly.

Immediately after the paper 31 is inserted into the printer device 1, the curl of the paper 31 is gentle, and the leading end of the paper 31 is positioned downstream in the conveyance direction beyond the gap 192, so that a possibility that the leading end of the paper 31 enters the gap 192 is low. However, since the curl of the paper 31 becomes stronger as the winding diameter of the rolled paper 30 becomes smaller, the possibility that the leading end of the paper 31 enters the gap 192 increases.

For example, when the printed paper portion is cut by the cutter mechanism 18 and then back-fed to the printing position of the thermal head 17, the leading end of the paper 31 needs to be stopped near the gap 192, so that there is a possibility that the leading end of the paper 31 enters the gap 192. Here, FIG. 3 illustrates a state in which the leading end of the paper 31 enters the gap 192.

In order to prevent the leading end of the paper 31 from entering the gap 192, it is possible to consider a measure of positioning the leading end of the paper 31 downstream away from the gap 192 (for example, a position facing the wall surface 191). However, in this case, since the leading end of the paper 31 is separated from the printing position, an extra space in which printing is not performed is generated in the leading end portion of the paper 31, which hinders efficient printing.

Therefore, the printer device 1 in the present embodiment includes a second guide unit 21 in order to reduce the curl that occurs on the paper 31. Hereinafter, the second guide unit 21 will be described.

The second guide unit 21 is an example of a guide unit. The second guide unit 21 is provided, for example, on the back surface side of the upper cover 12 at a position facing the damper unit 20. The second guide unit 21 forms, between the second guide unit 21 and the damper unit 20, a conveyance path for the paper 31 having a curved surface opposite to the curling tendency of the paper 31.

Specifically, the second guide unit 21 includes an upstream abutment portion 211 and a downstream abutment portion 212 at two positions sandwiching the damper unit 20 at the biasing position, the upstream abutment portion 211 and the downstream abutment portion 212 abutting against the paper 31 from the other surface side (winding inner surface side) of the paper 31. Each of the upstream abutment portion 211 and the downstream abutment portion 212 is an example of an abutment portion, and is a plate-shaped guide member extending downward from an upper side of the printer device 1.

The upstream abutment portion 211 is provided upstream of the damper unit 20 in the biasing position and at a position adjacent to the damper unit 20. A leading end of the upstream abutment portion 211 extends to a position lower than the damper unit 20 in the biasing position in a height direction of the printer device 1. A rotation roller 2111 that is rotatable in the conveyance direction is provided at the leading end of the upstream abutment portion 211. The leading end of the upstream abutment portion 211 may have a curved surface shape with chamfered corners.

The downstream abutment portion 212 is provided downstream of the damper unit 20 in the biasing position and at a position spaced apart from the damper unit 20. The leading end of the upstream abutment portion 211 extends to a position substantially equal to or higher than the damper unit 20 at the biasing position in the height direction of the printer device 1. Specifically, the downstream abutment portion 212 is provided at a position and a height that do not hinder a pivot operation of the damper unit 20. A rotation roller 2121 that is rotatable in the conveyance direction is provided at a leading end of the downstream abutment portion 212. The leading end of the downstream abutment portion 212 may have a curved surface shape with chamfered corners.

The second guide unit 21 forms the conveyance path of the paper 31 together with the damper unit 20. Specifically, the paper 31 is inserted between the damper unit 20 and the second guide unit 21 and conveyed between the upstream abutment portion 211, the damper unit 20, and the downstream abutment portion 212.

Here, the upstream abutment portion 211, the damper unit 20, and the downstream abutment portion 212 form a curved surface opposite to the curl of the paper 31. Specifically, the upstream abutment portion 211 and the downstream abutment portion 212 abut against the paper 31 from the winding inner surface side at a position corresponding to a base of the buffer region (projected region) of the paper 31 formed by the damper unit 20, thereby forming a curved surface opposite to the curling tendency on the paper 31.

The paper 31 passing through the damper unit 20 and the second guide unit 21 is curved (warped) in a direction opposite to the curling tendency in the conveyance path formed by the damper unit 20 and the second guide unit 21. That is, the damper unit 20 and the second guide unit 21 can curve the paper 31 in the direction opposite to the curling tendency, thereby sending the paper 31 with the curling tendency reduced (or corrected) to the thermal head 17.

Accordingly, the printer device 1 can reduce the possibility that the leading end portion of the paper 31 is caught by unevenness, a gap, or the like on the conveyance path, thereby reducing occurrence of a jam. For example, in the configuration in FIG. 2, since the leading end of the paper 31 can be prevented from entering the gap portion between the platen roller 16 and the first guide unit 19, the leading end of the paper 31 can be back-fed to a vicinity of the printing position, and efficient printing can be performed.

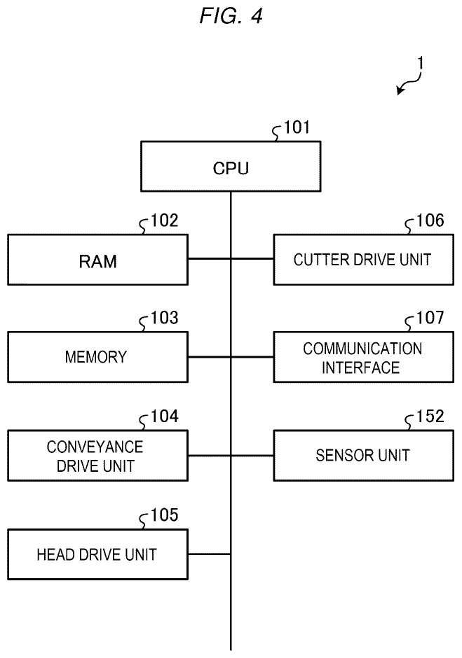

Next, a hardware configuration of the printer device 1 will be described with reference to FIG. 4. FIG. 4 is a diagram illustrating an example of the hardware configuration of the printer device 1 according to the embodiment.

As illustrated in FIG. 4, the printer device 1 includes a computer configuration such as a central processing unit (CPU) 101, a random access memory (RAM) 102, and a memory 103.

The CPU 101 is an example of a processor and a control unit, and comprehensively controls each unit of the printer device 1. The RAM 102 is a volatile storage medium and is used as a workspace for the CPU 101. For example, the RAM 102 is used as a storage area for temporarily storing print data to be printed on the paper 31. The print data is data to be printed.

The memory 103 is a non-volatile storage medium such as a read only memory (ROM) or a flash memory. The memory 103 stores various programs executed by the CPU 101 and setting information. For example, the memory 103 stores a program related to printing described later. In addition, the memory 103 stores setting information or the like that defines a relationship between the winding diameter of the rolled paper 30 and a handling operation described later. As an example, the memory 103 stores setting information in which the winding diameter of the rolled paper 30 and the number of times of the handling operation are stored in association with each other.

A program executed by the printer device 1 according to the present embodiment may be configured to be provided by being recorded in a computer-readable recording medium such as a CD-ROM, a flexible disk (FD), a CD-R, or a digital versatile disk (DVD) as a file in an installable format or an executable format.

Further, the program executed by the printer device 1 according to the present embodiment may be stored in a computer connected to a network such as the Internet and provided by being downloaded via the network. An operation program executed by the printer device 1 according to the present embodiment may be provided or distributed via a network such as the Internet.

In addition, a conveyance drive unit 104, a head drive unit 105, and a cutter drive unit 106 are connected to the CPU 101.

The conveyance drive unit 104 controls the conveyance of the paper 31 by driving the rolled paper rotation unit 151 and the platen roller 16. Specifically, the conveyance drive unit 104 controls an operation of a drive source (not illustrated) that drives the rolled paper rotation unit 151 and the platen roller 16 under control of the CPU 101 to convey the paper 31 in the feed direction or in the back-feed direction.

The rolled paper rotation unit 151 and the platen roller 16 may be driven by a common drive source, or may be driven by independent drive sources.

The head drive unit 105 controls an operation of the thermal head 17 by energizing the thermal head 17. Specifically, the head drive unit 105 generates a pulse signal (strobe signal) for driving (generating heat) the thermal head 17 under the control of the CPU 101. Then, the head drive unit 105 uses the generated strobe signal to cause the heating elements of the thermal head 17 to generate heat.

The cutter drive unit 106 controls an operation of the cutter mechanism 18 by driving the cutter mechanism 18. Specifically, the cutter drive unit 106 cuts the paper 31 by controlling an operation of a drive source (not illustrated) that drives an operating blade under the control of CPU 101.

A communication interface (I/F) 107 is connected to the CPU 101. The communication interface 107 is an interface for communicating with a host device (external device) such as a POS terminal. The communication interface 107 is, for example, infrared communication such as IrDA, Universal Serial Bus (USB), Local Area Network (LAN), RS-232C, or Bluetooth (registered trademark). The CPU 101 exchanges various kinds of information with the host device via the communication interface 107.

The printer device 1 includes the sensor unit 152 described with reference to FIG. 2. A sensor device in the printer device 1 is not limited to the sensor unit 152. For example, the printer device 1 may include an opening and closing sensor that detects opening and closing of the upper cover 12, a temperature sensor that measures a temperature of the thermal head 17, and the like.

In the printer device 1 having the above-described configuration, for example, the CPU 101 acquires print data transmitted from the host device via the communication interface 107. The acquired print data is temporarily stored in the RAM 102, and an image corresponding to the print data is printed on the paper 31 under the control of the CPU 101. More specifically, the CPU 101 controls the conveyance drive unit 104 to convey the paper 31 in the feed direction. The CPU 101 controls the operation of the head drive unit 105 based on the print data to print an image corresponding to the print data on the paper 31 conveyed in the feed direction. Next, when the printed paper 31 is discharged from the discharge port 13, the CPU 101 stops the conveyance in the feed direction and controls an operation of the cutter drive unit 106 to cut off a portion of the paper 31 on which the printing is performed. Then, the CPU 101 conveys the leading end of the paper 31 to the printing position of the thermal head 17 in the back-feed direction and waits for next printing.

It is preferable that, when the paper 31 is conveyed in the back-feed direction, the CPU 101 controls the rolled paper rotation unit 151 to rotate the rolled paper 30 in the back-feed direction, thereby controlling the paper 31 to be wound up. When conveying the paper 31 in the feed direction, the CPU 101 may control the rolled paper rotation unit 151 to rotate the rolled paper 30 in the feed direction or stop the rolled paper rotation unit 151.

If the winding diameter (remaining amount) of the rolled paper 30 detected by the sensor unit 152 falls below a threshold, the CPU 101 executes a handling operation of repeatedly performing conveyance in the back-feed direction and the feed direction. Here, a conveyance amount in the feed direction and the number of repetitions are not particularly limited, and can be freely set. For example, the conveyance amount in the feed direction may be a fixed value, or the conveyance amount may be dynamically changed according to print data to be printed next. The number of repetitions may be a fixed value such as once or may be dynamically changed according to the winding diameter (remaining amount). These settings related to the handling operation are stored in, for example, the setting information.

The paper 31 is conveyed in the back-feed direction within an area in which the leading end of the paper 31 does not exceed the printing position of the thermal head 17. A timing and the number of times of performing the handling operation are not particularly limited. For example, the handling operation may be performed at the same time as back-feeding the paper 31 after the paper 31 is cut.

As described above, in the printer device 1, if the winding diameter of the paper 31 falls below the threshold, the paper 31 is repeatedly conveyed in the back-feed direction and the feed direction, so that the paper 31 can be handled by the damper unit 20 and the second guide unit 21. Accordingly, in the printer device 1, even if the curvature of the curl that occurs in the paper 31 increases as the winding diameter decreases, it is possible to reduce (or correct) the curling tendency of the paper 31 by the handling operation. Therefore, in the printer device 1, it is possible to reduce the occurrence of a jam caused by the curling tendency of the paper 31, and thus printing can be performed efficiently.

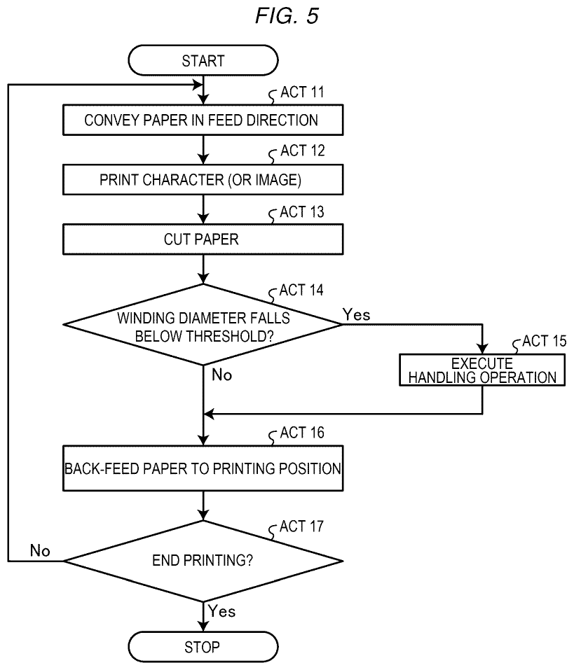

Next, an example of printing performed by the printer device 1 will be described with reference to FIG. 5. Here, FIG. 5 is a flowchart illustrating an example of printing performed by the printer device 1 according to the embodiment.

First, the CPU 101 of the printer device 1 controls the conveyance drive unit 104 to convey the paper 31 in the feed direction (ACT 11). Next, the CPU 101 controls the head drive unit 105 to print characters (or images) based on print data on the paper 31 (ACT 12). Next, the CPU 101 controls the cutter drive unit 106 to cut a leading end portion of the paper 31 on which printing is performed (ACT 13).

Subsequently, the CPU 101 determines whether the winding diameter of the rolled paper 30 falls below a threshold based on a detection result of the sensor unit 152 (ACT 14). If the winding diameter of the rolled paper 30 is equal to or larger than the threshold (ACT 14; No), the CPU 101 controls the conveyance drive unit 104 to back-feed the paper 31 to a printing position (ACT 16).

Meanwhile, if the winding diameter of the rolled paper 30 falls below the threshold (ACT 14; Yes), the CPU 101 controls the conveyance drive unit 104 to execute a handling operation of performing conveyance in the back-feed direction and the feed direction a predetermined number of times (ACT 15). If the handling operation is completed, the CPU 101 proceeds to ACT 16 and conveys the paper 31 to the printing position.

Subsequently, the CPU 101 determines whether to end the printing (ACT 17). For example, if a predetermined number of papers are printed, the CPU 101 determines to end the printing. If it is determined not to end the printing (ACT 17; No), the CPU 101 returns the process to ACT 11 to continue printing on the paper 31. If it is determined to end the printing (ACT 17; Yes), the CPU 101 ends the present process.

As described above, the printer device 1 according to the present embodiment includes: the accommodation portion 15 that accommodates the paper 31 wound in a roll shape; the platen roller 16 that pulls out the paper 31 from the accommodation portion 15 and conveys the paper 31; the thermal head 17 that prints on the conveyed paper 31; the damper unit 20 provided between the accommodation portion 15 and the thermal head 17 and abutting against the paper 31 from the winding outer surface side of the paper 31 to apply an elastic force to the paper 31; and the second guide unit 21 facing the damper unit 20, and forming, between the second guide unit 21 and the damper unit 20, a conveyance path of the paper 31 having a curved surface opposite to the curling tendency of the paper 31.

Accordingly, the printer device 1 can reduce (or correct) the curling tendency that occurs on the paper 31 while the paper 31 passes through the damper unit 20 and the second guide unit 21, and thus can perform printing on the paper 31 with the curling tendency reduced. In addition, since the printer device 1 can reduce a fluctuation in tension applied to the paper 31 by the damper unit 20, stable conveyance can be achieved. Therefore, the printer device 1 can efficiently perform printing on the paper 31 and improve the printing quality.

While the embodiment has been described, the embodiment has been presented by way of example and is not intended to limit the scope of the disclosure. The novel embodiments described herein can be implemented in a variety of other forms; and various omissions, substitutions, changes, and combinations can be made without departing from the spirit of the disclosure. These embodiments and modifications thereof are included in the scope and the gist of the exemplary embodiments, and are included in a scope of the exemplary embodiments disclosed in the claims and equivalents thereof.

What is claimed is:

1. A printer device, comprising:
an accommodation portion configured to accommodate paper wound in a roll shape;
a conveyance component configured to pull out the paper from the accommodation portion and convey the paper;
a printing component configured to print on the paper conveyed by the conveyance component;
a damper component provided between the accommodation portion and the printing component, the damper component configured to abut against the paper from a winding outer surface side of the paper so as to apply an elastic force to the paper; and
a guide component facing the damper component, the guide component configured to form, between the guide component and the damper component, a conveyance path of the paper having a curved surface opposite to a curling tendency of the paper.

2. The printer device according to claim 1, wherein
the damper component presses the paper from the winding outer surface side to form a projected region on the paper, the projected region being curved in a direction opposite to the curling tendency of the paper, and
the guide component comprises an abutment portion that abuts against the paper from a winding inner surface side of the paper at a position corresponding to a base of the projected region.

3. The printer device according to claim 1, further comprising:
a sensor configured to detect a winding diameter of the paper accommodated in the accommodation portion; and
a controller configured to control an operation of the conveyance component, wherein
if the winding diameter of the paper falls below a threshold, the controller causes the conveyance component to execute a handling operation a predetermined number of times, the handling operation repeating conveyance in a first conveyance direction in which the paper is conveyed toward the printing component and conveyance in a second conveyance direction opposite to the first conveyance direction.

4. The printer device according to claim 3, further comprising:
a rotation component configured to rotate the paper in the roll shape accommodated in the accommodation portion in the second conveyance direction, wherein
the controller controls an operation of the rotation component to rotate the paper in the roll shape in the second conveyance direction when the paper is conveyed in the second conveyance direction.

5. The printer device according to claim 3, further comprising:
a cutting component configured to cut a portion of the paper printed by the printing component, wherein
the controller causes the conveyance component to execute the handling operation each time the paper is cut by the cutting component.

6. The printer device according to claim 3, wherein the sensor is further configured to detect a remaining amount of paper wound in the roll shape, and a near-end approaching an end of the paper wound in the roll shape.

7. The printer device according to claim 1, wherein the conveyance component comprises a platen roller.

8. A method of mitigating paper curling, comprising:
accommodating paper wound in a roll shape an accommodation portion of a printer;
pulling out the paper from the accommodation portion and conveying the paper using a conveyance component;
printing on the paper conveyed;
abutting a damper component against the paper from a winding outer surface side of the paper so as to apply an elastic force to the paper using a damper component between the accommodation portion and the printer; and
forming, between the guide component and the damper component, a conveyance path of the paper having a curved surface opposite to a curling tendency of the paper using a guide component facing the damper component.

9. The method according to claim 8, wherein
pressing the paper from the winding outer surface side to form a projected region on the paper using the damper component, the projected region being curved in a direction opposite to the curling tendency of the paper, wherein
the guide component comprises an abutment portion that abuts against the paper from a winding inner surface side of the paper at a position corresponding to a base of the projected region.

10. The method according to claim 8, further comprising:
detecting a winding diameter of the paper accommodated in the accommodation portion;
controlling an operation of the conveyance component; and
if the winding diameter of the paper falls below a threshold, causing the conveyance component to execute a handling operation a predetermined number of times, the handling operation repeating conveyance in a first conveyance direction in which the paper is conveyed toward the printer and conveyance in a second conveyance direction opposite to the first conveyance direction.

11. The method according to claim 10, further comprising:
rotating the paper in the roll shape accommodated in the accommodation portion in the second conveyance direction; and
controlling rotating the paper in the roll shape in the second conveyance direction when the paper is conveyed in the second conveyance direction.

12. The method according to claim 10, further comprising:
cutting a portion of the paper printed by the printer; and
causing the conveyance component to execute the handling operation each time the paper is cut.

13. The method according to claim 10, further comprising:
detecting a remaining amount of paper wound in the roll shape and a near-end approaching an end of the paper wound in the roll shape.

14. A thermal printer, comprising:
an accommodation portion configured to accommodate a roll of paper;
a conveyance component configured to pull out the paper from the accommodation portion and convey the paper;
a thermal printing head configured to print on the paper conveyed by the conveyance component;
a damper component provided between the accommodation portion and the thermal printing head, the damper component configured to abut against the paper from a winding outer surface side of the paper so as to apply an elastic force to the paper; and
a guide component facing the damper component, the guide component configured to form, between the guide component and the damper component, a conveyance path of the paper having a curved surface opposite to a curling tendency of the paper.

15. The thermal printer according to claim 14, wherein
the damper component presses the paper from the winding outer surface side to form a projected region on the paper, the projected region being curved in a direction opposite to the curling tendency of the paper, and
the guide component comprises an abutment portion that abuts against the paper from a winding inner surface side of the paper at a position corresponding to a base of the projected region.

16. The thermal printer according to claim 14, further comprising:
a sensor configured to detect a winding diameter of the roll of paper accommodated in the accommodation portion; and
a controller configured to control an operation of the conveyance component, wherein
if the winding diameter of the paper falls below a threshold, the controller causes the conveyance component to execute a handling operation a predetermined number of times, the handling operation repeating conveyance in a first conveyance direction in which the paper is conveyed toward the thermal printing head and conveyance in a second conveyance direction opposite to the first conveyance direction.

17. The thermal printer according to claim 16, further comprising:
a rotation component configured to rotate the paper accommodated in the accommodation portion in the second conveyance direction, wherein
the controller controls an operation of the rotation component to rotate the paper in the second conveyance direction when the paper is conveyed in the second conveyance direction.

18. The thermal printer according to claim 16, further comprising:
a cutting component configured to cut a portion of the paper printed by the thermal printing head, wherein
the controller causes the conveyance component to execute the handling operation each time the paper is cut by the cutting component.

19. The thermal printer according to claim 16, wherein the sensor is further configured to detect a remaining amount of paper in the roll of paper, and a near-end approaching an end of the paper in the roll of paper.

20. The thermal printer according to claim 14, wherein the conveyance component comprises a platen roller.
